(19) United States
(12) Patent Application Publication
(10) Pub. No.: US 2016/0259063 A1
(43) Pub. Date: Sep. 8, 2016

(54) INTEGRATED SOLID STATE SCINTILLATOR DOSIMETER

(71) Applicant: Senaya, Inc., Boston, MA (US)

(72) Inventors: Brian Lee, Boston, MA (US); Dadi Setiadi, Edina, MN (US)

(21) Appl. No.: 15/058,448

(22) Filed: Mar. 2, 2016

Related U.S. Application Data
(60) Provisional application No. 62/129,359, filed on Mar. 6, 2015.

(51) Int. Cl. G01T 1/02; G01T 1/20

(52) U.S. Cl. CPC G01T 1/023; G01T 1/2018

(57) ABSTRACT

An integrated solid state dosimeter comprising a silicon PiN photodiode, and a scintillator material directly on and optically coupled with the photodiode. The scintillator material can be deposited on the photodiode at a temperature less than 350 degrees C. Multiple dosimeters can be combined, either as a 2D or 3D array. The dosimeter(s) can be incorporated into a wireless dosimeter device.

### CROSS REFERENCE

This application claims priority under 35 U.S.C. 119(e) to U.S. provisional application 62/129,359, filed Mar. 6, 2015, the entire disclosure of which is incorporated herein for all purposes.

### FIELD OF THE DISCLOSURE

The present disclosure is directed to integrated solid state scintillator dosimeters and devices that incorporate those dosimeters.

### BACKGROUND

Solid state sensors use solid-phase materials such as semiconductors to quantify radiation interaction through the collection of charge in the solid state masses. As the radiation particle travels through the solid state mass, electron-hole pairs are generated along the particle path. The motion of the electron-hole pair in an applied electric field generates the basic electrical signal from the detector.

One of example of a solid state dosimeter is a diode dosimeter. An example of a diode dosimeter is a silicon diode dosimeter, which utilizes a P-N junction diode. The diodes are formed by counter-doping the surface of N-type or P-type silicon to produce the opposite type material. These diodes are referred to as N—Si or P—Si dosimeters, depending upon the base material. When these dosimeters are exposed to radiation, electron-hole (e-h) pairs are produced in the body of the dosimeter including the depletion layer. The charges (minority carriers) produced in the body of the dosimeter, within the diffusion length, diffuse into the depleted region. The charges are swept across the depletion region under the action of an electric field due to the intrinsic potential. In this way, a current is generated in the reverse direction in the diode. The diodes are used in the short circuit mode, since this mode exhibits a linear relationship between the measured charge and dose. They are usually operated without an external bias to reduce leakage current.

Advantages of a diode dosimeter are that it is more sensitive and smaller in size compared to typical ionization chambers.

A disadvantage of a diode is that is has to be calibrated and several correction factors have to be applied for dose calculation. The sensitivity of the diode depends on its radiation history, so the calibration has to be repeated periodically.

Another disadvantage of a diode is that it also shows a variation in dose response with temperature, dependence of signal on the dose rate (care should be taken for different source-skin distances), angular (directional) dependence and energy dependence even for small variation in the spectral composition of radiation beams (important for the measurement of entrance and exit doses).

Another example of a solid state dosimeter uses a Metal-Oxide Semiconductor Field Effect Transistor (MOSFET) as the detector element and the associated electronics measure the change in the threshold voltage required to maintain the device at a specified operating point. A MOSFET dosimeter measures the effect of radiation on the gate oxide rather than the silicon, but uses the results to infer a silicon dose. MOSFETs are small in size even compared to diodes, offering very little attenuation of the beam when used for in-vivo dosimetry.

A disadvantage of the degradation dosimeter technique is that it is indirect, in that, the device does not measure radiation dose but the radiation effects upon a specific device. Not all devices degrade in the same way or at the same rate, and the understanding of rate and annealing effects become critical. These indirect radiation effects make the interpretation of the device output prone to serious error. A pre-irradiation test of a passive solid state dosimeter is usually performed to establish an operational curve that represents the degradation as a function of the dose received.

Furthermore, similarly to diodes, MOSFETs exhibit temperature dependence. Due to their non-linearity of response with total absorbed dose, regular sensitivity checks are required. MOSFETs are also sensitive to changes in the bias voltage during irradiation (it must be stable) and their response drifts slightly after the irradiation (the reading must be taken in a specified time after exposure). Additionally, they have a limited life-span.

Another example of indirect measurement type solid state sensor is a scintillator in which energy absorbed from incident radiation or charged particles is converted into light. Usually the light generated in the scintillator during its irradiation is carried away by an optical fiber to an electronic light sensor located outside the irradiation room such as a photomultiplier tube (PMT), photodiode, or silicon photomultiplier. Photon detectors absorb the light emitted by the scintillator and reemit it in the form of electrons via the photoelectric effect. The subsequent multiplication of those electrons (sometimes called photo-electrons) results in an electrical pulse which can then be analyzed and yield meaningful information about the particle that originally struck the scintillator.

A typical setup requires two sets of optical fibers which are coupled to two different electronic light sensors, allowing subtraction of the background Cerenkov radiation from the measured signal. The response of the scintillation dosimeter is linear in the dose range of therapeutic interest. An advantage of a scintillator is that it is nearly energy independent and can thus be used directly for relative dose measurements. Another advantage of a scintillator is that the dosimeter can be made very small (about 1 mm³ or less) and yet have adequate sensitivity for clinical dosimetry. Hence, it can be used in cases where high spatial resolution is required (e.g., high dose gradient regions, buildup regions, interface regions, small field dosimetry, etc.). A scintillator also has good reproducibility and long term stability. Scintillators suffer no significant radiation damage (up to about 10 kGy) although the light yield should be monitored when used clinically, and they have no significant directional dependence and need no ambient temperature or pressure corrections. Particle energy deposited in a scintillator is proportional to the scintillator's response. Therefore, scintillators could be used to identify various types of gamma-quanta and particles in fluxes of mixed radiation.

A disadvantage of scintillators is the manufacturing cost of producing them. Most crystal scintillators require high-purity chemicals and sometimes rare-earth metals that are fairly expensive.

In general, a solid state dosimeter (SSD) has many advantages over other types of dosimeters in terms of power consumption, form factor, ease of use, noise level, linearity, low maintenance, ruggedness, etc. However, currently available SSD's are not good enough in terms of its sensitivity, reliability, cost, noise level, linearity, etc.

### SUMMARY

The present disclosure relates to an integrated solid state scintillator dosimeter, and devices incorporating an integrated solid state scintillator dosimeter, having a scintillator material layer deposited directly on the top of a silicon PiN photodiode, e.g., at low temperature (e.g., less than 350 degree C.). The scintillator layer is optically coupled with the photodiode. Both the P-layer and N-layer of the silicon photodiode are heavily doped, and a depletion region is sandwiched between these heavily doped layers. By processing at low temperature (e.g., less than 350 degrees C.), the process is compatible for CMOS integration.

In one embodiment, at least two integrated solid state scintillator dosimeters are stacked together to form a 3D multilayer dosimeter. Each integrated solid state scintillator dosimeter is sensitive to a certain energy range or a type of radiation to be detected, thus, the stacked, multilayer dosimeter can detect multiple energy ranges or types of radiation.

In another embodiment, a 2D array of integrated solid state scintillator dosimeters is formed using a single element of integrated solid state dosimeters. Each single element uses the same scintillator material layer optically coupled to the silicon photodiode. Each single element is separated with exactly the same pitch. A high fill factor of single elements is achieved using simplified readout electronics.

An integrated solid state scintillator dosimeter device can measure both radiation dose and dose rate in real time. The integrated solid state scintillator dosimeter device is able to detect alpha, beta, and gamma species by various protective layers over the integrated solid state scintillator dosimeter, and is able to measure the energy of radiation species, meaning, that the sensor can distinguish distinct radiations.

In one embodiment, a first stage of readout electronics for the integrated solid state scintillator dosimeter device consists only of four transistors.

In another embodiment, a first stage of readout electronics for the integrated solid state scintillator dosimeter device includes a charge sensitive amplifier. A charge amplifier can include two transistors and a single feedback capacitor.

Any of the dosimeters can be incorporated into a device that includes at least one integrated solid state dosimeter; a positioning unit (e.g., GPS); a battery; and a control unit operably connected to a transceiver for transmission of data representative of the radiation data detected by each dosimeter. In some embodiments, the dosimeter(s) and transceiver are wirelessly connected.

Any of the dosimeters and/or dosimeter devices can be incorporated into a system that includes at least one, and typically a plurality of, solid state dosimeter devices, and a remote host that includes a transceiver suitable for communicating with the dosimeter(s) or dosimeter device(s). In some embodiments, the dosimeter(s) and transceiver are wireless.

### BRIEF DESCRIPTION OF THE DRAWING

The disclosure may be more completely understood in consideration of the following detailed description of various embodiments of the disclosure in connection with the accompanying drawing, in which:

FIG. 1 is a schematic diagram of a radiation exposure monitoring system.

FIG. 2 is a schematic diagram of a solid state dosimeter (SSD) which has a scintillator and a silicon photo detector.

FIG. 3 is a schematic diagram of an embodiment of a dosimeter incorporating an SSD.

FIG. 4 is a schematic diagram of another embodiment of a dosimeter incorporating an SSD.

FIG. 5 is a schematic diagram of a multiple layer (three dimensional) dosimeter incorporating SSDs.

FIG. 6 is a schematic diagram of two embodiments of dosimeters formed by two dimensional arrays of SSDs.

FIG. 7 is a schematic diagram of a four transistors SSD.

FIG. 8 is a schematic diagram of a two transistor SSD with a capacitor feedback.

FIG. 9 is a schematic diagram of a readout circuit including comparator and charge counter circuitry.

FIG. 10 is a schematic diagram of a comparator circuit.

FIG. 11 is a schematic diagram of a charge counter circuit.

FIG. 12 is a schematic diagram of an omnibus sensor structure.

FIG. 13 is a schematic diagram of an omnibus radon detector structure.

### DETAILED DESCRIPTION

There are many different types of radiation detectors or dosimeters for monitoring exposure to hazardous ionizing radiation such as x-rays, gamma rays, electrons and neutrons. Various radiation measurement technologies currently exist, including Thermo Luminescent Dosimeter (TLD), Optically Stimulated Luminescence (OSL) dosimeters, electronic dosimeters, quartz or carbon fiber electrets, and other solid-state radiation measurement devices.

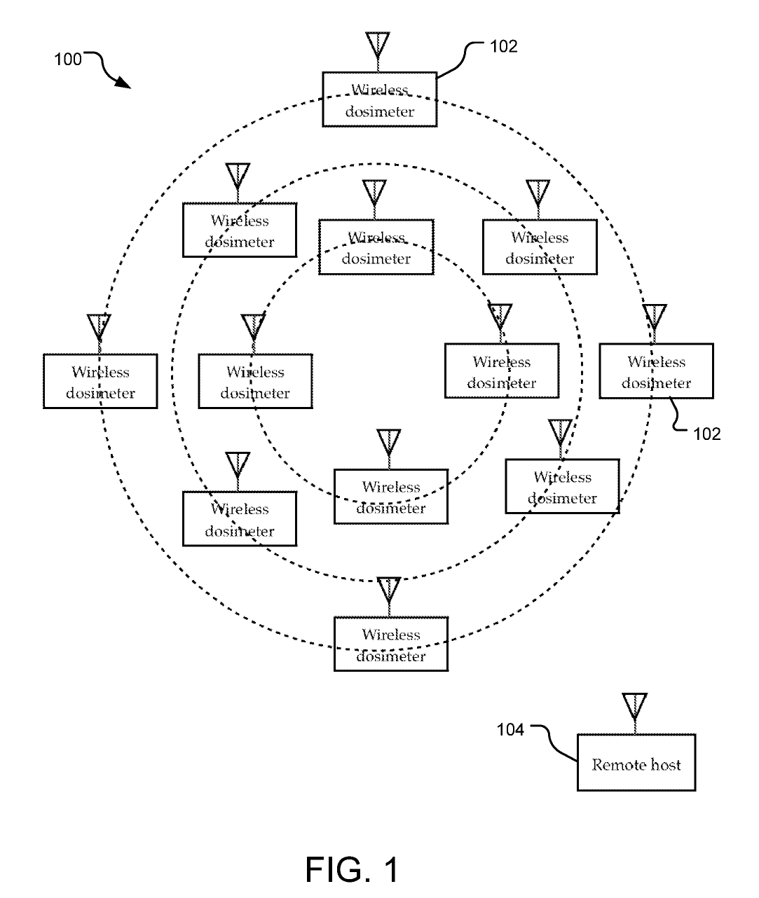

FIG. 1 illustrates an example of a radiation exposure monitoring system 100. The radiation monitoring system 100 and variations thereof includes at least one wireless dosimeter device 102, and a remote host receiver 104 for receiving the location signal from the wireless dosimeter device(s). A “wireless dosimeter” and variations thereof, is a portable, signal emitting device configured for placement in pre-existing premises, such as a room or building or spot or contaminated area. At least one of the wireless dosimeter devices 102 of the system 100 is an integrated solid state scintillator dosimeter device according to this disclosure.

The radiation exposure monitoring system 100 typically has each a wireless dosimeter device 102 associated with a premise (e.g., the device 102 is located on or at a location). The wireless dosimeter device 102 is an active RF tag, having the capability to actively transmit and/or provide interactive information to the remote host receiver 104. The remote host receiver 104 is operably connected to a computer, server, or display, not shown. A monitoring system, also not shown, uses an established wireless communication network (e.g., wireless RF communication network) to identify the location of the wireless dosimeter(s) and convey that information to the computer, server or display. Examples of wireless RF communication networks with which the monitoring system 100 can function include ZigBee, Bluetooth Low Energy (BLE), WiFi (sometimes referred to as WLAN), LTE, and WiMax. In some embodiments, a CDMA/GMS communication network, which can be considered to be a cellular frequency, may be additionally or alternately used.

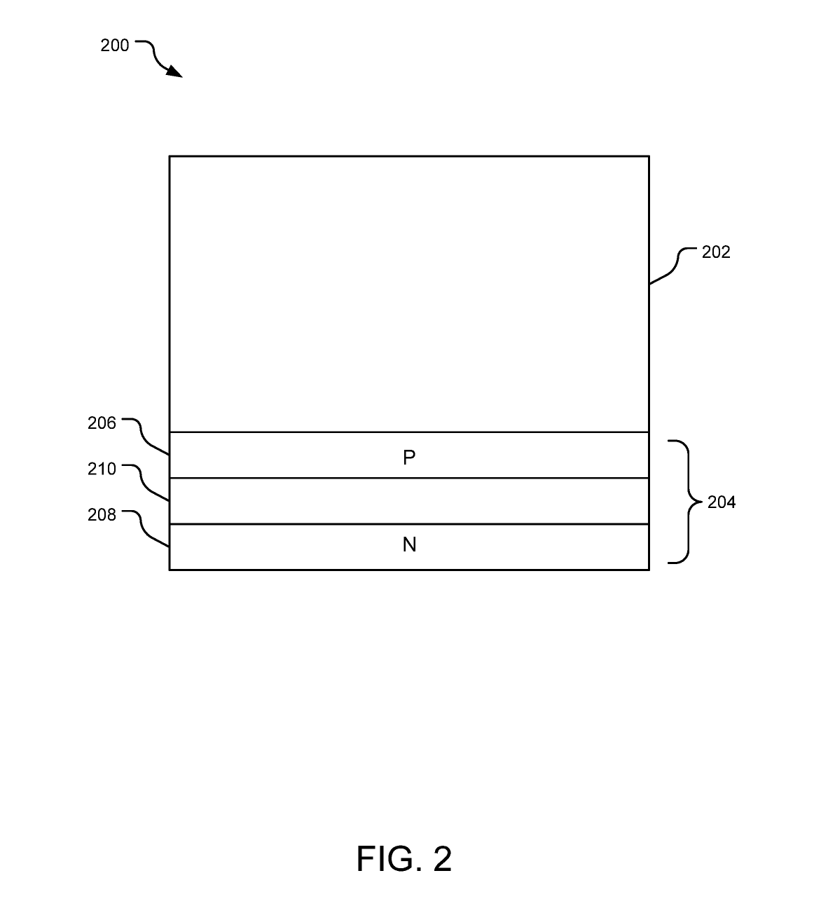

The wireless dosimeter device 102 includes a micro dosimeter to detect radiation. The micro dosimeter can be an integrated solid state scintillator dosimeter, in which energy absorbed from incident radiation or charged particles is converted into light by a scintillator material. The scintillator material is integrated directly on a silicon photodiode as shown in FIG. 2. The silicon photodiode then converts the generated light into an electrical signal. In such a manner, total ionizing dose (TID) is measured indirectly through a generated light of the integrated solid state scintillator dosimeter.

FIG. 2 provides an example of integrated solid state scintillator dosimeter 200. Here, a scintillator material layer 202 is deposited directly on the top of a photodiode 204 and is optically coupled with the photodiode 204. The photodiode 204 has a heavily doped P-layer 206 and a heavily doped N-layer 208 of the silicon photodiode, and a depletion region 210 sandwiched between these heavily doped layers 206, 208. The photodiode 204 has high sensitivity, a low voltage (<3.5V) operating condition, and is able to detect low energy secondary photon packets.

Since the scintillator material layer 202 is directly on top of the silicon photodiode 204 and optically coupled thereto, a generated light (photon) from the absorbed energy will maximally convert into an electrical signal in highest conversion factor, reducing a mechanism loss from absorbed energy into absorbed photon in the silicon photodiode 204.

A number of scintillator materials can be integrated onto the silicon photodiode 204 depending on the desired energy range, type of radiation to be detected, environmental constraints, deposition technology, etc. One preferred material is inorganic crystal, such as those that can be deposited or formed at low temperature (e.g., less than 350 degrees C.). Advantages of an inorganic crystal are its excellent and stable light output, its linearity, its fast response, and its energy resolution. A disadvantage of the inorganic crystal is its hygroscopicity, which requires it to be housed in an air-tight enclosure to protect it from moisture.

A first example of a scintillator material is gadolinium oxysulfide (Gd₂O₂S), which emits light at wavelengths between 382-622 nm and has a high density (about 7.32 g/cm³). Gadolinium oxysulfide is often used in its polycrystalline form, and can be used in medical diagnostic applications (e.g., x-ray imaging). Gadolinium oxysulfide can be doped, e.g., terbium doped gadolinium oxysulfide (Gd₂O₂S:Tb) and phosphors doped gadolinium oxysulfide (Gd₂O₂S:Pr), which are both useable scintillators.

A second example of a scintillator material is cesium iodide (CsI), which can be doped to form CsI(T1), or cesium iodide doped with thallium, and CsI(Na), or cesium iodide doped with sodium. Undoped cesium iodide (CsI) emits predominantly in the 315 nm band and has a very short decay time (16 ns), making it suitable for fast timing applications. CsI(T1) is one of the brightest scintillators and emits in 550 nm band. CsI(Na) is less bright than CsI(T1), but comparable in light output to NaI(T1). CsI(Na) has a slightly shorter decay time than CsI(T1) (i.e., 630 ns versus 1000 ns for CsI(T1)).

Other examples of scintillator material are LaCl₃(Ce), or lanthanum chloride doped with cerium; LaBr₃(Ce), or cerium-doped lanthanum bromide; CaF₂(Eu), or calcium fluoride doped with europium; BGO (bismuth germinate); and LYSO(Ce), PbWO₄CdWO₄, YSO(Ce), PbF2, YAG(Ce), and YAP(Ce)

As indicated above, the scintillator material 202 can be deposited on to the photodiode 204 at a low temperature, such as at less than 350 degrees C. depending on the scintillator material and/or other factors (e.g., processing parameters). In some embodiments, the deposition may be done at a temperature less than 340 degrees C., less than 330 degrees C., less than 325 degrees C., less than 320 degrees C., less than 310 degrees C., less than 300 degrees C., less than 290 degrees C., less than 280 degrees C., less than 275 degrees C., less than 270 degrees C., less than 260 degrees C., or less than 250 degrees C.

The resulting scintillator layer 202 has a thickness between, e.g., 500 and 10000 micrometers, as compared to the PiN silicon photodiode 204 that has a thickness typically less than about 10 micrometers.

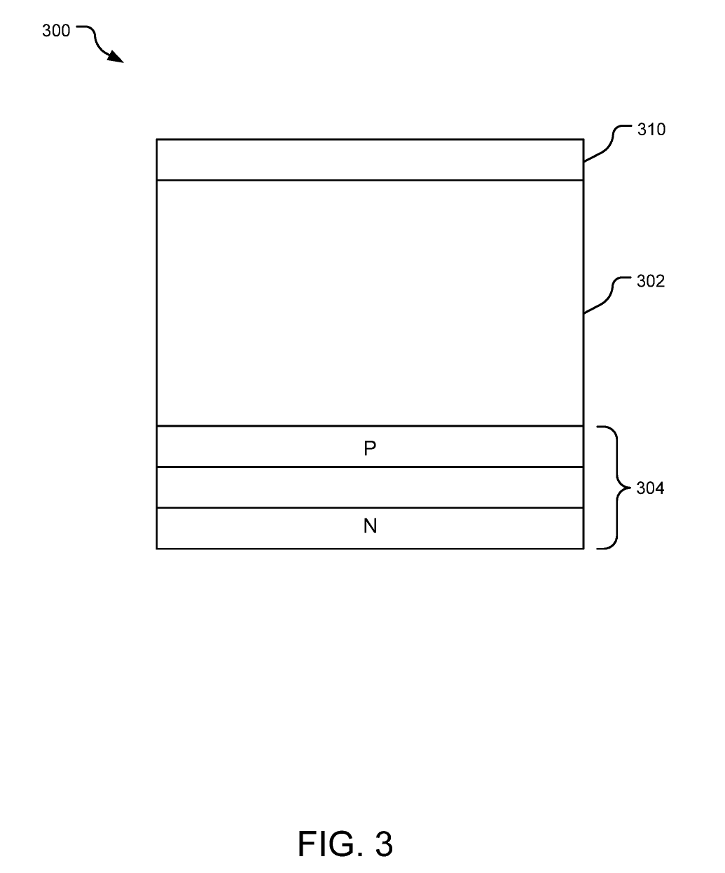

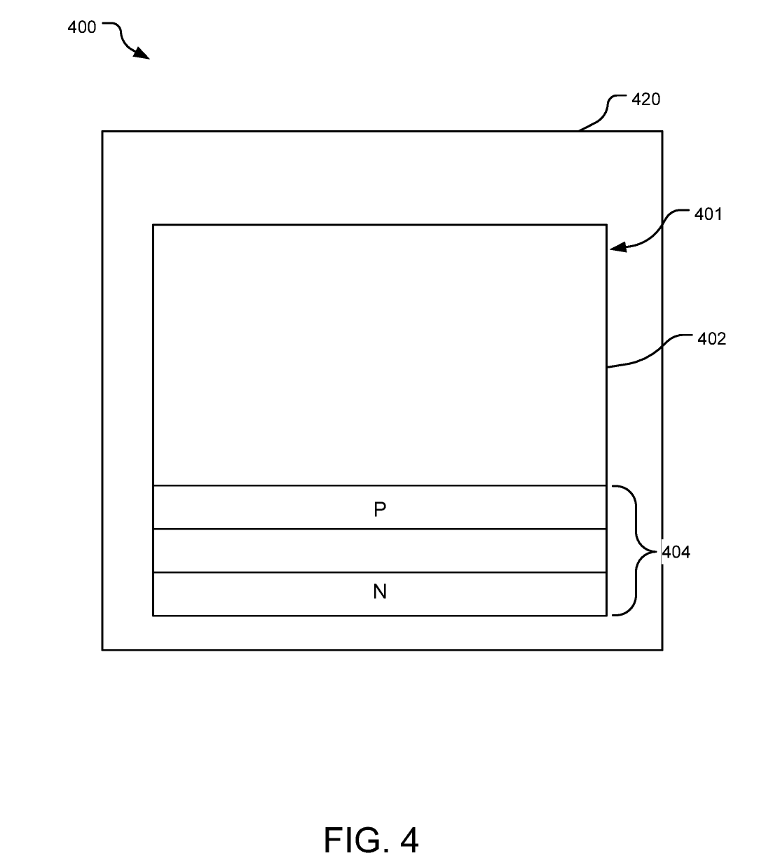

FIGS. 3 through 4 provide various examples of how an integrated solid state scintillator dosimeter can be designed and/or adapted for detection of specific radiation particles or species.

FIG. 3 shows an example of an integrated scintillator dosimeter 300, particularly for detecting alpha or beta particles. The dosimeter 300 has a scintillator layer 302 on a photodiode 304 and also has a thin opaque cover layer 310 present on the top of the scintillator layer 302. Although not called out, the photodiode 304 has a heavily doped P-layer, a heavily doped N-layer, and a depletion region between the doped layers. For detection of alpha particles, a suitable cover layer 310 is mica, approximately 150 micrometers thick, although other materials and thicknesses are suitable. This cover layer 310 covers the surface of the scintillator layer 302 that is opposite the photodiode 304. In other embodiments, the cover layer 310 may extend partially down or along the sides of the scintillator layer 302.

FIG. 4 shows another example of an integrated scintillator dosimeter 400, particularly configured to detect X-ray and gamma particles. As shown in FIG. 4, the dosimeter 400 includes the base integrated solid state dosimeter 401 having a scintillator layer 402 on a photodiode 404. An opaque cover layer 420 envelopes the integrated scintillator dosimeter 401, encasing all sides of the dosimeter 401. Suitable materials and thicknesses of the cover layer 420 are similar to those of the cover layer 310 of dosimeter 300.

In other embodiments, depending on the material of the cover layer 310, 420 and the desired properties of the resulting dosimeter, the cover layer 310, 420 may cover more or less surfaces than shown in FIGS. 3 and 4.

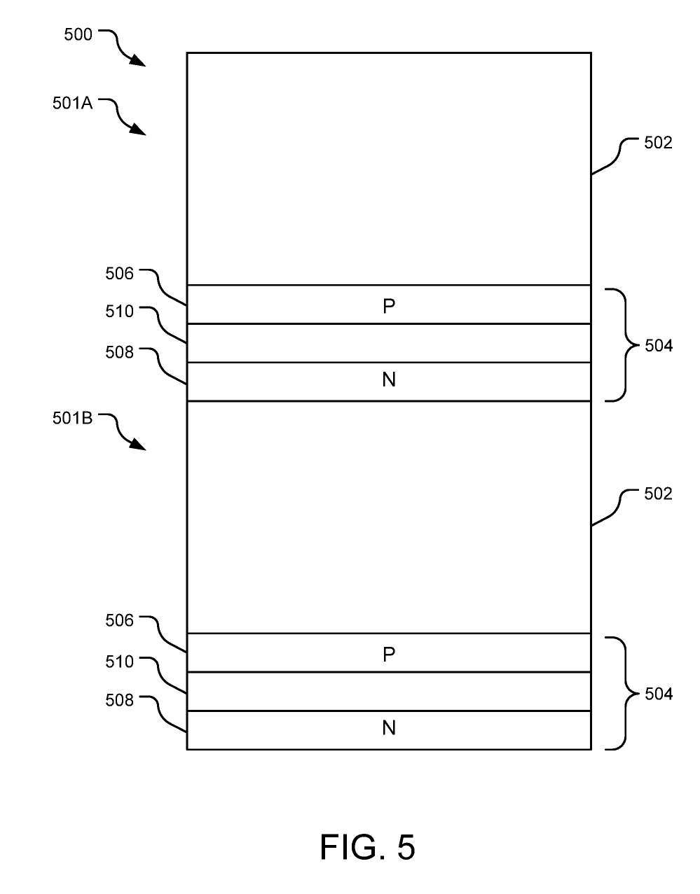

Multiple integrated solid state scintillator dosimeter devices can be stacked together to create a three dimensional (3D) multilayer dosimeter. FIG. 5 is a schematic diagram of a 3D multiple layer solid state dosimeter 500. The particular stacked dosimeter 500 is formed by stacking two integrated solid state scintillator dosimeters 501A, 501B although alternate embodiments may have more than two stacked dosimeters. As in the previous embodiments, each integrated solid state scintillator dosimeter 501A, 501B has a scintillator material 502 on a photodiode 504 that has a heavily doped P-layer 506, a heavily doped N-layer 508, and a depletion region 510 between the doped layers 506, 508. The two integrated solid state scintillator dosimeters 501A, 501B may be identical or different (non-identical), based on the desired detection of the overall dosimeter 500.

Two or more identical dosimeters 501A, 501B will detect the same radiation on both dosimeters 501A, 501B. Non-identical integrated solid state scintillator dosimeters 501A, 501B, each sensitive to a different energy range or a type of radiation, will detect different radiation types or different ranges.

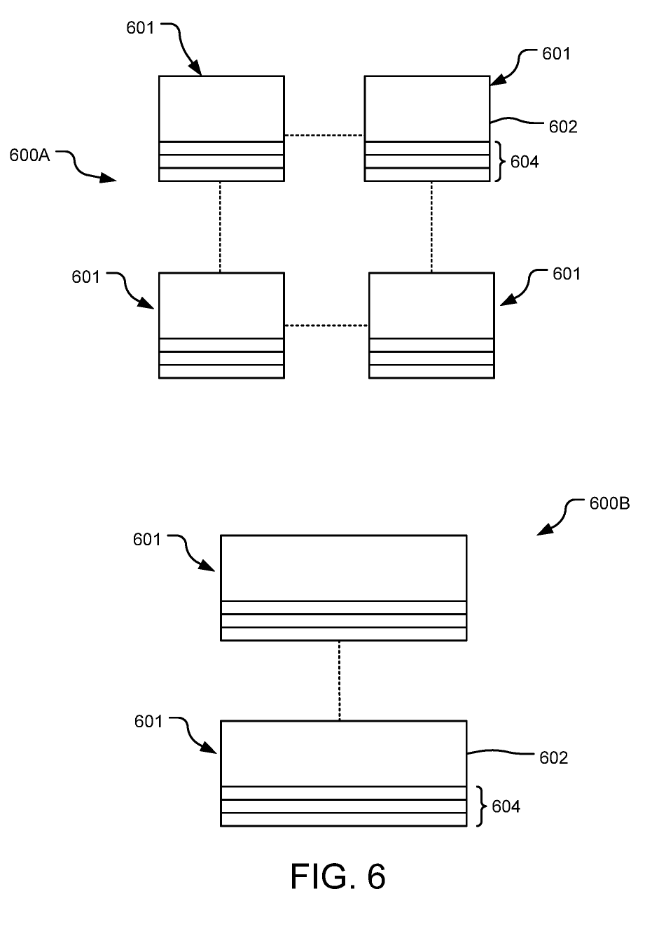

In other embodiments, two dimensional (2D) of scintillator dosimeters can be formed by an array of single integrated solid state dosimeters. FIG. 6 illustrates two schematic diagrams of two 2D arrays of solid state dosimeters. Array 600A is a N×N array (2D) of integrated solid state scintillator dosimeters 601 and array 600B is a N×1 array (1D) of integrated solid state scintillator dosimeters 601, where N is a positive whole number (in the particular embodiment, N=2). Each array 600A, 600B is formed from multiple, single element integrated solid state dosimeters 601. Each single element dosimeter 601 has the same scintillator material layer 602 optically coupled to the silicon photodiode 604. In each array 600A, 600B, each single element dosimeter 601 is separated from the adjacent one with exactly the same pitch.

A high fill factor of single elements 601 is achieved using simplified readout electronic. An array of photodiodes (e.g., 100×100 to 1,000×1,000 or 100 raws-1,000 raws) is used to minimize drift induced signal lagging. A preferred design for a two dimensional (2D) array has large area (e.g., greater than a 5 mm×5 mm radiation active area) and thick (e.g., >500 um) scintillator, low voltage (e.g., <3.6V), low current (e.g., Ion<100 uA, Ioff<0.1 uA), low electron noise (<5 e-rms), high speed electron counting (e.g., <1 ns) and sensing circuitry. The total CMOS area, including active and inactive radiation sensing parts, is e.g., less than about 15 mm×15 mm, or, 225 mm².

Any of the dosimeter embodiments (e.g., individual dosimeter or the 3D or 2D arrays) can be integrated with a low power system interface product (SIP), Analog Digital Converter (ADC), central processing unit (CPU) and/or general purpose input/outputs (GPIOs) to form a dosimeter device. Further, they can be integrated with any or all of a wireless communication module(s), compact battery pack, user interface that includes any of a light emitting diode (LED), sound, liquid crystal display (LCD), etc. The dosimeter devices can provide realtime reporting network and analytics, provide realtime reporting and monitoring system, and have extremely low noise (e.g., <5 e-(rms)) and a high dynamic range (>120 dB). Additionally, the dosimeter embodiments may be integrated with other environmental and/or safety monitoring systems.

The integrated solid state scintillator dosimeter device measures one or both dose and dose rate in real time, is able to detect any or all of alpha, beta and gamma particles due to different protective layers in the integrated solid state scintillator dosimeter, and is able to measure the energy of radiation species (meaning, that the sensor can distinguish between different radiations within the range of radiations from K40 to Cs137).

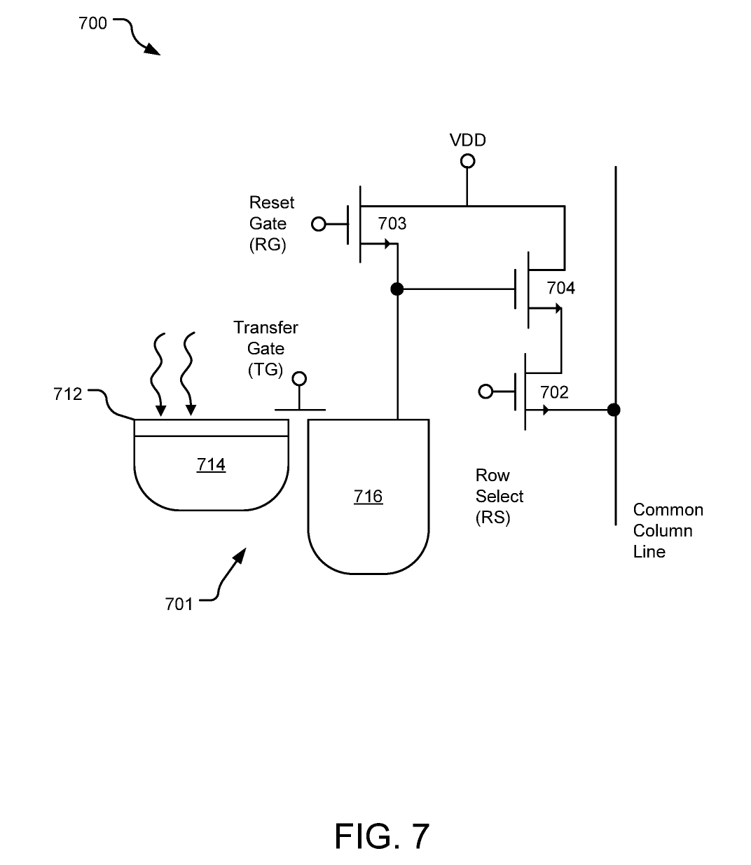

As indicated above, any of the dosimeters described herein can be incorporated into a dosimeter device. FIGS. 7 through 11 are various representations of dosimeter devices.

FIG. 7 is a hybrid schematic diagram of a device that has a four transistor SSD configuration, the figure depicting some method steps and also electronic schematics. A first stage 700 of readout electronics for an integrated solid state dosimeter device has only four transistors 701, 702, 703, 704. The first transistor 701 is shown having a source 714 and a drain 716, the source 714 having a dosimeter formed by a photodiode (not illustrated). A scintillator material 712 is deposited on the top of the source 714 of the first transistor 701 and the drain 716 of the first transistor 701 is a floating diffusion. By applying voltage to the gate of the first transistor 701, the gate voltage of the fourth transistor 704 is controlled. The gate voltage of the fourth transistor 704 depends on the amount of light generated by the scintillator material 712. A gate of the third transistor 703 functions as a reset gate for the first stage of the readout electronics 700, while the gate of the second transistor 702 functions as a row select.

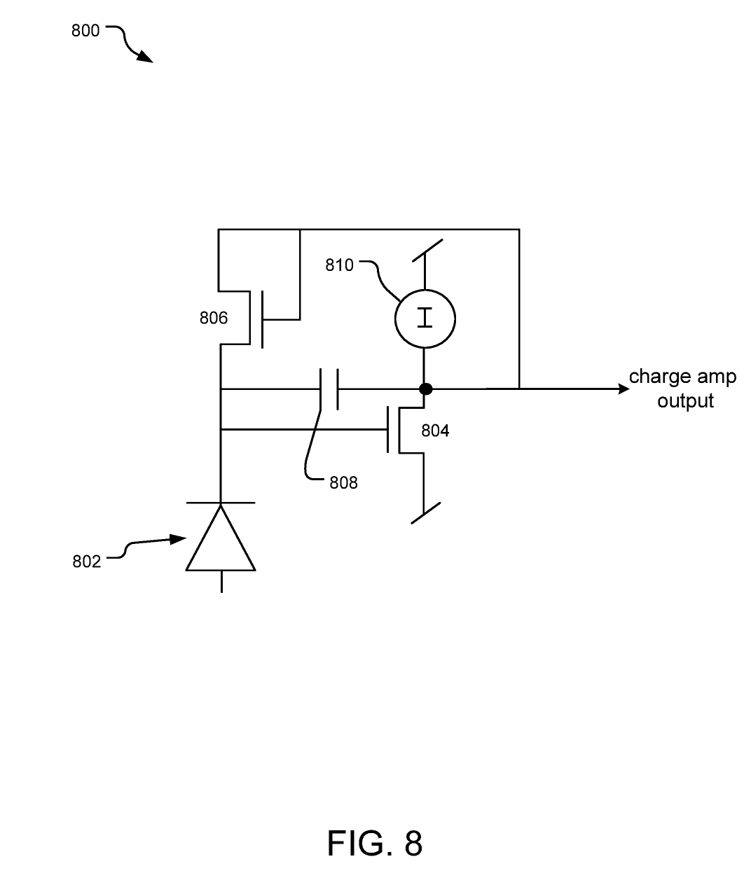

In another embodiment, a charge amplifier 800 is shown in FIG. 8. In FIG. 8, a scintillator material is present on the top of a photodiode, thus forming an integrated scintillator photodiode 802. The charge amplifier 800 has two transistors, a main transistor 804 and an auxiliary transistor 806, and a single feedback capacitor 808. The feedback capacitor 808, e.g., roughly 0.1 fF, is connected between the source and gate of the main transistor 804. The auxiliary transistor 806 provides a constant voltage to the gate of the main transistor 804, while a charge generated by the integrated scintillator photodiode 802 is amplified by the main transistor 804. A current source 810 is operably connected with the source of the main transistor 804 while the drain of the main transistor 804 is connected to ground.

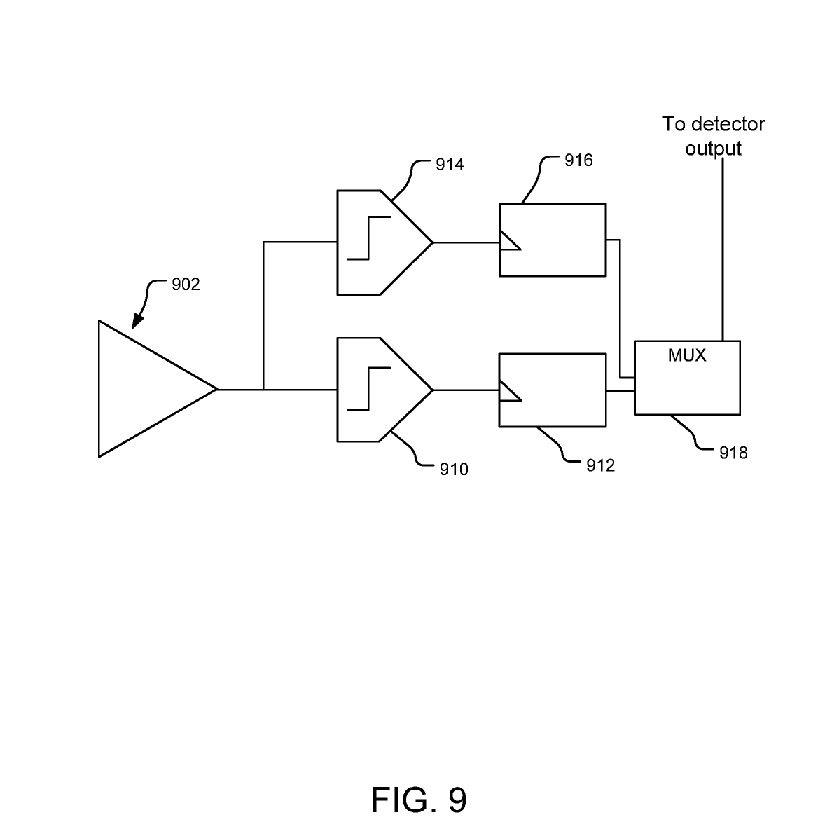

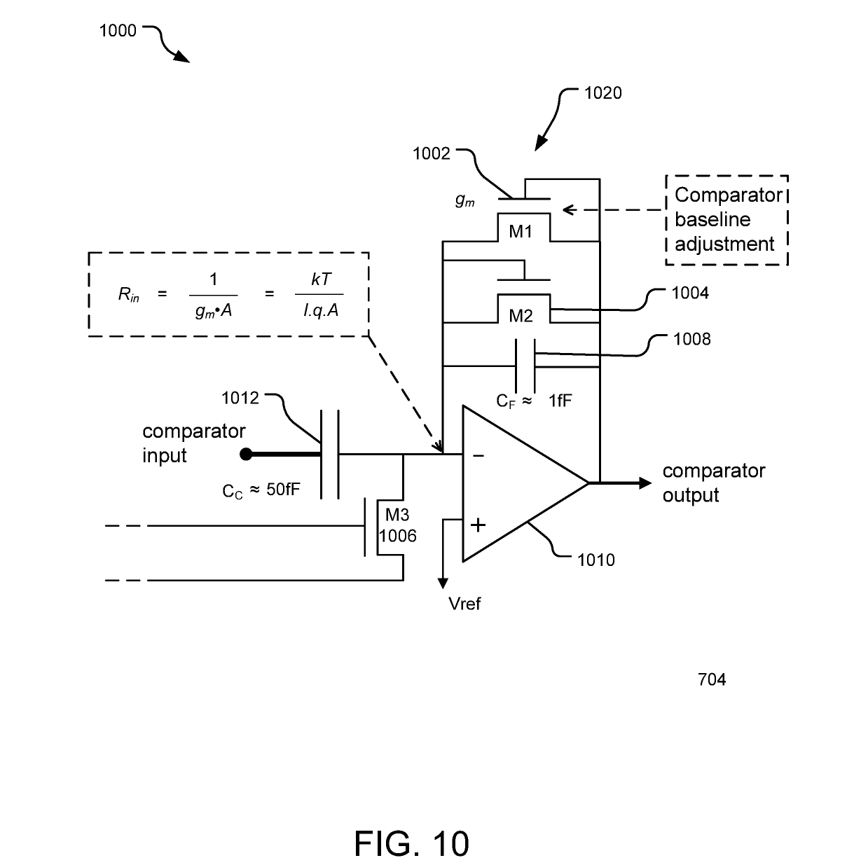

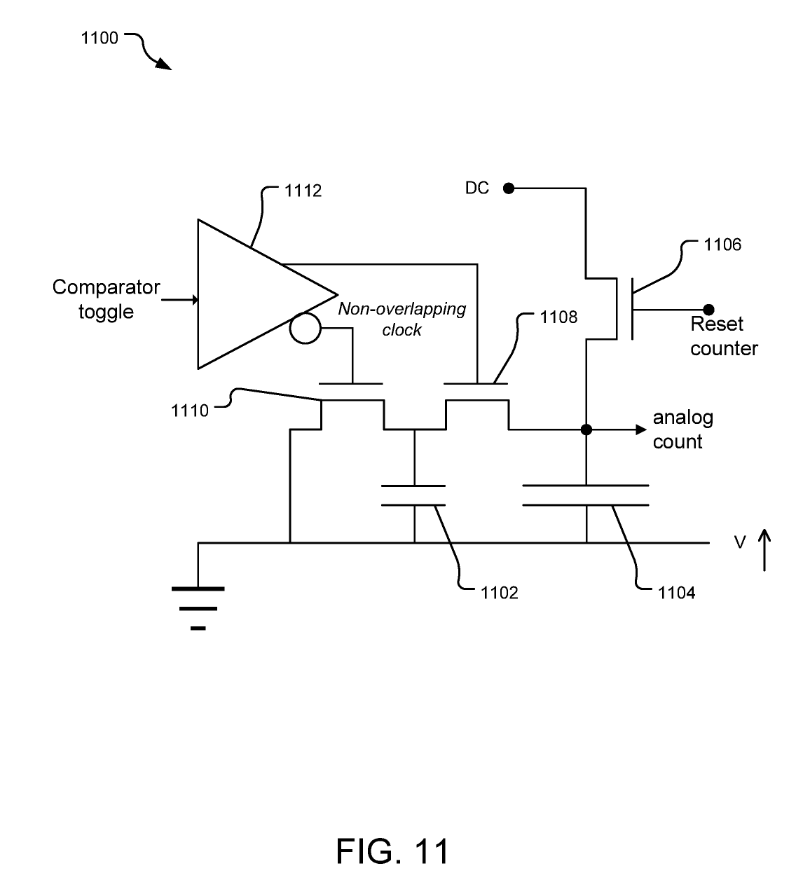

The schematic diagram of FIG. 9 represents a single element of the integrated solid state dosimeter. It includes a charge sensitive amplifier 902 (e.g., the charge amplifier 800 of FIG. 8) with first and second comparator circuits 910 and 914 (e.g., as shown detail in FIG. 10 and described in detail below), first and second charge counter circuits 912 and 916 (e.g., as shown detail in FIG. 11 and described in detail below), and a multiplexer (MUX) circuit 918. The first circuits 910, 912 are parallel to the second circuits 914, 916. An output of the charge sensitive amplifier 902 is connected to the comparator circuits 910, 914 through to the charge counter circuits 912, 916. From the charge counter circuits 912, 916, the signals are delivered through a multiplexer (MUX) 918. This readout electronic provides extremely low electron noise (<5 e-(rms)), and high dynamic range (>120 dB).

FIG. 10 shows a schematic diagram of a comparator circuit 1000 that can be used in the single element of the integrated solid state dosimeter of FIG. 9. The comparator circuit 1000 has a differential pair amplifier 1010, an input capacitor Cc 1012, and a feedback circuit 1020. The feedback circuit 1020 has a feedback capacitor Cf 1008, and transistors M1 1002 and M2 1004. A gate of transistor M1 1002 is connected to the output of differential amplifier 1010 as a comparator baseline adjustment. A value of the feedback capacitor 1008 can be about 1 fF. A first input of the differential pair amplifier 1010 is connected to a voltage reference Vref, while a second input of the differential pair amplifier 1010 is connected to M3 1006 and the input capacitor Cc 1012. A value of the input capacitor 1012 can be about 50 fF. An output of the charge sensitive amplifier 902 is connected to the input capacitor Cc 1012. A comparator 1000 output node is connected to a comparator toggle of a charge counter 1100 as shown in FIG. 11.

FIG. 11 shows a schematic diagram of a direct current (DC) charge counter circuit 1100 that can be used in the single element of the integrated solid state dosimeter of FIG. 9. The charge counter circuit 1100 has a dual ended amplifier 1112 with a non-overlapping clock, charge capacitors 1102 and 1104, a bias transistor 1106, and input transistors 1108 and 1110. A gate of the bias transistor 1106 functions as a reset counter. The gate of transistor 1108 and the gate of transistor 1110 are controlled by the non-overlapping clock which governs the charging of the capacitors 1102, 1104. An analog output of the charge counter circuit goes through the multiplexer as shown in FIG. 9 to any next circuit (not shown).

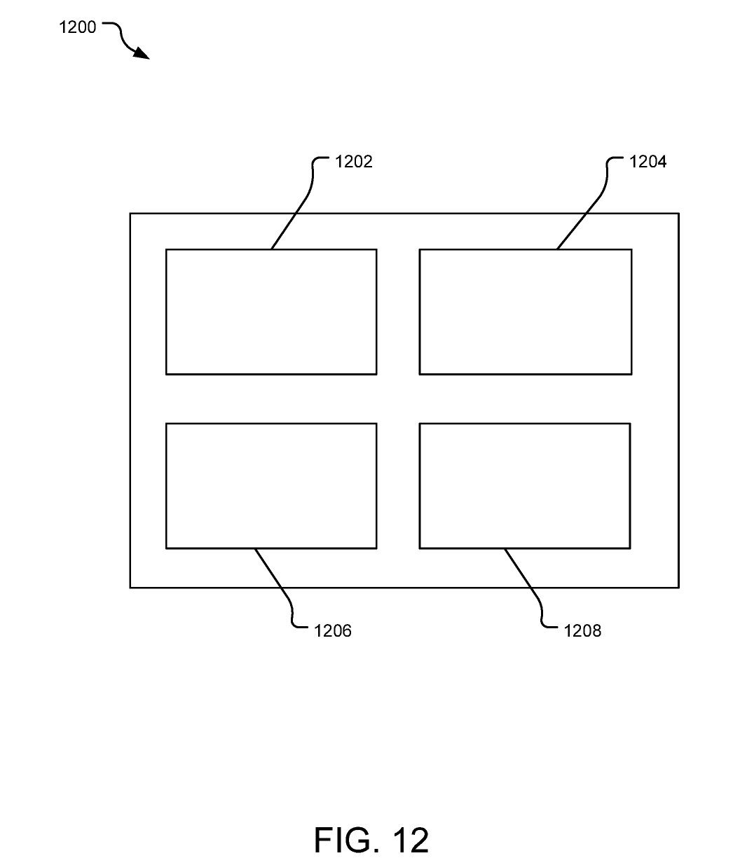

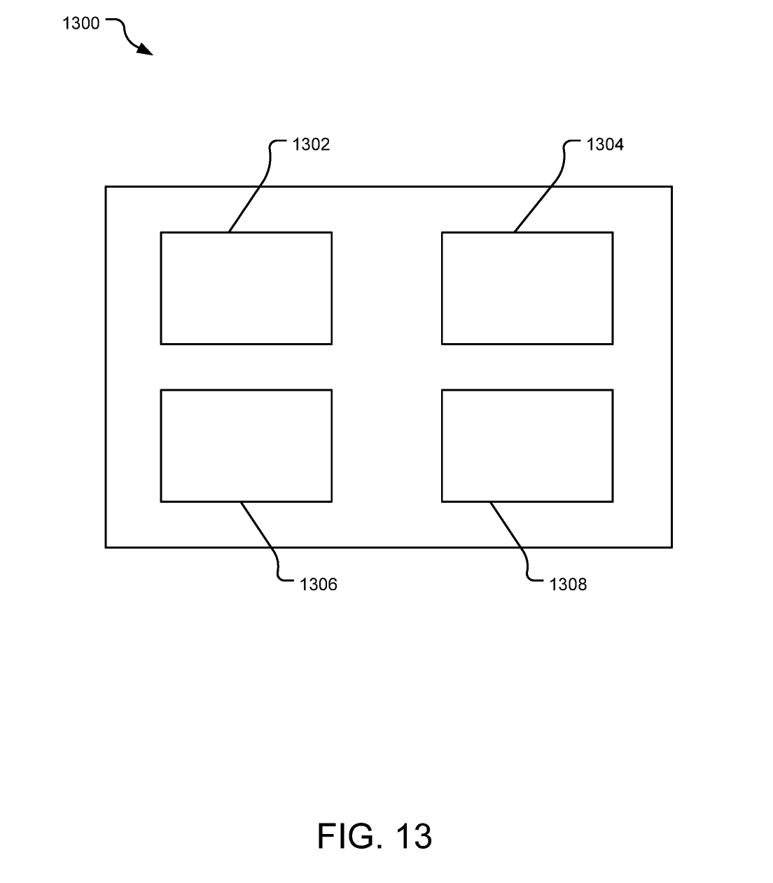

In one and more embodiments, a single dosimeter device is composed of multiple integrated solid state scintillator radiation dosimeters that are able to detect any or all of alpha, beta and gamma particles at the same time. FIG. 12 shows an example of such an omnibus sensor device 1200. This sensor device 1200 includes an alpha particle detection dosimeter 1202, a beta particle detection dosimeter 1204, a gamma particle detection dosimeter 1206, and also has a reference photo detector 1208, which may also be an integrated solid state scintillator dosimeter. In another embodiment, the integrated dosimeter device also includes auxiliary sensors such as temperature sensor(s), humidity sensor(s), and/or pressure sensor(s). FIG. 13 shows a schematic diagram of omnibus radon detector device 1300 having various other sensors, such as environmental senor(s). The device 1300 has a radiation (e.g., alpha particles) detector or dosimeter 1302, a temperature sensor 1302, a humidity sensor 1306, and a pressure sensor 1308. Any or all of the sensors or detectors of structure 1300 can be incorporated with any or all of the dosimeters of sensor structure 1200.

Additionally, the integrated solid state dosimeters of this description can be incorporated into any of the embodiments of dosimeter devices and radiation detection system that are disclosed in Applicant's co-pending U.S. patent application that has published as U.S. 2015/0237419, the entire disclosure of which is incorporated herein by reference.

The above specification and examples provide a complete description of the structure and use of exemplary implementations of the invention. The above description provides specific implementations. It is to be understood that other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Spatially related terms, including but not limited to, “bottom,” “lower”, “top”, “upper”, “beneath”, “below”, “above”, “on top”, “on,” etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as below or beneath other elements would then be above or over those other elements.

Since many implementations of the invention can be made without departing from the spirit and scope of the invention, the invention resides in the claims hereinafter appended. Furthermore, structural features of the different implementations may be combined in yet another implementation without departing from the recited claims.

What is claimed is:

1. An integrated solid state dosimeter comprising:
a silicon PiN photodiode, and
a scintillator material directly on and optically coupled with the photodiode.

2. The integrated solid state dosimeter of claim 1, wherein the scintillator material comprises at least one of: CsI or cesium iodide; CsI(T1) or cesium iodide doped with thallium; CsI(Na) or cesium iodide doped with sodium; Gd₂O₂S or gadolinium oxysulfide.

3. The integrated solid state dosimeter of claim 1, wherein the scintillator material comprises inorganic crystal.

4. The integrated solid state dosimeter of claim 1, wherein the silicon PiN photodiode comprises a doped P-layer, a doped N-layer, and a depletion region therebetween.

5. The integrated solid state dosimeter of claim 1, wherein the scintillator layer is 500 to 10,000 micrometers thick.

6. The integrated solid state dosimeter of claim 5, wherein the silicon PiN photodiode is no more than 10 micrometers thick.

7. The integrated solid state dosimeter of claim 1 configured to detect only one of alpha radiation, beta radiation, or gamma radiation.

8. The integrated solid state dosimeter of claim 1 configured to measure one or both of radiation dose and radiation dose rate, in real time.

9. A plurality of the integrated solid state dosimeters of claim 1 arranged in a 1×N 1D array, where N is 1 to 1000.

10. The plurality of the integrated solid state dosimeters of claim 9, configured to detect at least two of alpha radiation, beta radiation, and gamma radiation.

11. The plurality of the integrated solid state dosimeters of claim 9, configured to detect all of alpha radiation, beta radiation, and gamma radiation.

12. A plurality of the integrated solid state dosimeters of claim 1, arranged in a N×N 2D array, where N is 1 to 1000.

13. The plurality of the integrated solid state dosimeters of claim 12, configured to detect at least two of alpha radiation, beta radiation, and gamma radiation.

14. The plurality of the integrated solid state dosimeters of claim 12, configured to detect all of alpha radiation, beta radiation, and gamma radiation.

15. A plurality of the integrated solid state dosimeters of claim 1 stacked to form a 3D array.

16. The plurality of the integrated solid state dosimeters of claim 15, wherein at least two of the plurality of the integrated solid state dosimeters are different.

17. The plurality of the integrated solid state dosimeters of claim 16, configured to detect at least two of alpha radiation, beta radiation, and gamma radiation.

18. The plurality of the integrated solid state dosimeters of claim 16, configured to detect all of alpha radiation, beta radiation, and gamma radiation.

19. An integrated solid state dosimeter comprising:
a silicon PiN photodiode, and
a low-temperature, inorganic scintillator material directly on and optically coupled with the photodiode.

20. A wireless dosimeter device comprising:
at least one integrated solid state dosimeter comprising a silicon PiN photodiode, and a scintillator material directly on and optically coupled with the photodiode;
a positioning unit;
a battery; and
a control unit operably connected to a wireless transceiver for transmission of data representative of the radiation data detected by each dosimeter.
